(19) United States
(12) Patent Application Publication
(10) Pub. No.: US 2024/0399902 A1
(43) Pub. Date: Dec. 5, 2024

(54) SUPPLY CABLE FOR A VEHICLE

(71) Applicant: Robert Bosch GmbH, Stuttgart (DE)

(72) Inventors: Georg Wallensteiner, Gemmrigheim (DE); Markus Schreiber, Markgroeningen (DE); Martin Schmidt, Stuttgart (DE)

(21) Appl. No.: 18/699,559

(22) PCT Filed: Sep. 27, 2022
(86) PCT No.: PCT/EP2022/076756

§ 371 Date: May 22, 2024

(30) Foreign Application Priority Data
Oct. 8, 2021 (DE) 10 2021 211 385.0

(51) Int. Cl. B60L 53/18; A01M 29/10; A01M 29/18; B60L 53/16

(52) U.S. Cl. CPC B60L 53/18; A01M 29/10; A01M 29/18; B60L 53/16

(57) ABSTRACT

A supply cable for electrically connecting a vehicle to an energy supply apparatus that supplies electrical energy and/or to a load that requires electrical energy. The supply cable includes: a connecting line; a primary connector which is electrically couplable or coupled to the connecting line and has a vehicle terminal for detachable electrical connection to the vehicle, in particular to the energy storage device; a secondary connector which is electrically couplable or coupled to the connecting line and has a secondary terminal which is provided for detachable electrical connection to the energy supply apparatus or to the electrical load; a detection unit for detecting animals in the surroundings of the supply cable; and an output unit for outputting scaring signals for scaring off the detected animal.

### FIELD

The present invention relates to a supply cable for electrically connecting a vehicle, in particular an energy storage device of a vehicle, wherein the connection can be established in particular with an energy supply apparatus and/or with a load. The present invention also relates to a primary connector of a supply cable. The present invention also relates to a secondary connector of a supply cable.

### BACKGROUND INFORMATION

Various approaches are described in the related art for electrically charging electric vehicles or hybrid vehicles (e.g., cars, trucks, boats, aircraft, two-wheelers, etc.). A charging of the vehicle can take place in a first charging situation via a dedicated charging infrastructure, wherein the charging stations are in particular fixedly installed charging stations. For example, such charging stations are realized as a charging column or wall box. In an alternative charging situation, a continuous current socket is provided, as is used, for example, in normal households for energy supply. For example, this is a (e.g., 230 V) Schuko (protective contact) socket or a socket designed in accordance with other regional standards or customs, wherein a three-phase current connection can also be provided. In this case, a connecting line of the charging cable generally has an integrated controller, which is also referred to as an in-cable control box, ICCB, and which is arranged between the two connectors within the connecting line. This integrated controller serves to communicate with the vehicle and to release and set a charging current since, in contrast to a charging column or a wall box, a Schuko socket generally does not have a communication line via which the vehicle can communicate with the energy supply apparatus.

If the supply cable is used to charge the vehicle, the supply cable is usually left unattended (e.g., when charging overnight). This means that animals such as martens or rats can approach the supply cable unnoticed and possibly damage it by biting it. It is generally described in the related art that cables can be protected against animal biting.

German Patent Application No. DE 103 43 040 A1, for example, describes a metal helix that can be arranged around a cable. Solar technology is specified as the application, wherein the said metal coil is to be fitted around the fixed cabling of the solar elements. The metal coil prevents animals such as martens from gaining access to the cable.

German Patent Application No. DE 298 19 821 U1 describes a cable in whose sheath additional conductors are inserted that are permanently energized. If a marten bites into this cable, it is prevented from biting again by the electric shock due to the additional wires in the cable sheath and therefore does not damage the individual conductors within the cable sheath. However, a marten bite will inevitably damage the cable sheath until the electrical wires prevent the marten from biting further. However, it also cannot be ruled out that the animal's bite may penetrate signal lines or power lines. Finally, the related art describes use of electric shock plates which are intended to give a marten or similar animal an electric shock to scare it off when the marten touches these plates.

### SUMMARY

A supply cable according to the present invention allows animals to be scared off. In the context of the present invention, the term “animal” is understood in particular to mean an animal which is dangerous or potentially harmful to cables, i.e., which can damage the supply cable and/or a supply line of the supply cable, for example by biting or gnawing. In particular, such animals are considered to be mammals and, among the mammals rodents or predators in particular, further in particular rats and/or mice and/or martens and/or other animals known in regions of the world other than Europe for animal biting on cables or lines or nibbling on cables and/or lines (for example monkeys, etc.). The supply cable does not require any additional external components such as metal coils. This makes the supply cable compact, flexible, easy to handle and, in particular, easy to fold up and stow in the trunk of a vehicle. In addition, the supply cable without metal coils, etc. is better protected against dirt that can accumulate between the coils, and is also advantageously easier to clean (e.g., by wiping off dirt or moisture). Attaching metal coils or other components that physically prevent access to the cable but are also inconvenient for a user to handle would restrict the manageability of the supply cable and increase the space required in the trunk of the vehicle, both of which are avoided by the proposed supply cable. Such metal coils, etc. are particularly suitable for permanently installed cables that are not handled flexibly by a user on a daily basis. The supply cable also allows animals to be scared off before they damage the supply cable. This avoids the situation where an animal first has to bite into the supply cable and then be driven off by an electric shock or something similar. This means that the supply cable remains intact and live wires, even if they only serve as a defense against animals, are not exposed after an animal bite. This is particularly advantageous for supply cables, because they are mostly used outdoors and can also rest on the ground. Exposed live wires would be particularly disadvantageous in wet conditions, such as when there are puddles, and pose a risk of electric shock to the user of the supply cable. In principle, it is advantageous for the supply cable that no electric shocks are used to scare off animals, which on the one hand makes it more animal-friendly and on the other hand eliminates the potential risk that a user of the supply cable would receive an electric shock. In addition, such supply cables are quite expensive, and a partially bitten or nibbled supply cable may still have to be replaced. There may therefore be a need for a supply cable that is easy and flexible to handle, that can be flexibly folded or rolled up and with which an animal can be scared off before it bites or otherwise damages the supply cable and/or a supply line of the supply cable.

According to an example embodiment of the present invention, the supply cable is used to electrically connect a vehicle, or an energy storage device of a vehicle, to an energy supply apparatus that supplies electrical energy (thus the vehicle can be charged and the supply cable acts as a charging cable) and/or to a load that requires electrical energy or another vehicle (thus the vehicle serves as an energy source for the load or the other vehicle and the supply cable acts as a power cable for the load or the other vehicle, e.g., when its battery is depleted, etc.). The supply cable has a connecting line and a primary connector. The primary connector can be electrically coupled to the connecting line (e.g., in the manner of an exchangeable adapter) or coupled in a non-destructively detachable manner (the primary connector can also be referred to as a charging connector, for example, if the supply cable is used as a charging cable). The primary connector also has a vehicle terminal for detachable electrical connection to the vehicle, in particular the energy storage device. The supply cable also has a secondary connector. The secondary connector can be electrically coupled to the connecting line (e.g., in the form of an exchangeable adapter) or, for example, cannot be detached non-destructively and is intended for detachable electrical connection to the energy supply apparatus or to the electrical load.

According to an example embodiment of the present invention, the supply cable also has a detection unit. The detection unit is used to detect animals in the surroundings of the supply cable. For example, in an area around the supply cable of up to 10 m or an area around the supply cable of up to 5 m or an area around the supply cable of up to 3 m. Advantageously, this detection is carried out by means of optical and/or acoustic detection and/or by detection based on echo ranging and/or movement patterns of the supply cable, in particular the connecting line. Acoustic detection means in particular that acoustic signals are detected which indicate the presence of an animal, i.e., acoustic signals caused by the animal. Echo ranging is, in particular, ultrasonic and/or radar localization. The optical detection is preferably an active or passive optical detection, for example optical detection using a camera and/or optical detection using optical measurement systems such as LiDAR.

According to an example embodiment of the present invention, the supply cable furthermore has an output unit. The output unit is used to output scaring signals to scare off the detected animal. The scaring signals are advantageously predefined signals. These signals can be emitted, for example, as soon as an animal is present in the detection range of the detection unit. The detection unit is designed in particular to detect the presence of an animal. As soon as an animal is detected, the output unit advantageously emits scaring signals. In a preferred embodiment, the detection unit or another component of the supply cable also makes it possible to classify the detected animal. This makes it possible to select the scaring signal to be output, wherein different scaring signals are predefined in particular for different animal classifications. This makes it possible for detected animals to be effectively scared off. It may be advantageous to emit the at least one scaring signal (a single scaring signal or a plurality of different scaring signals or types of scaring signals may be provided) via the output unit only when (or exactly when) the detection unit has detected an animal. This has the advantage of reducing energy consumption. Furthermore, this advantageously prevents interference with the area surrounding the supply cable due to constant emission of the at least one scaring signal. This can be a great advantage in residential areas, for example.

A particular advantage of the supply cable according to the example embodiment of the present invention is that it also protects the vehicle connected or connectable to the supply cable from damage, for example from animal biting or the like. In this way, it is advantageous to dispense with a vehicle's own animal repellent device (e.g., “marten repellent”), especially if a user connects the vehicle to the energy supply apparatus with the supply cable, for example, after parking, especially at night or when it is dark.

Preferred developments of the present invention are disclosed herein.

Preferably, the detection unit is designed as an ultrasonic sensor and/or a camera for detecting the animal. The ultrasonic sensors can be used to determine whether a body is present in the detection range of the ultrasonic sensor. For example, the presence of an animal can be inferred from a movement, in particular a characteristic movement. The presence of an animal or a harmful animal can also be inferred based on other information, e.g., a characteristic signal signature, e.g., based on the strength or scattering of the reflected signal, because typical harmful animals usually have a characteristic range of body size and usually have fur. The camera can be used to optically detect a surrounding area, wherein the camera's image data can be used to recognize whether an animal is present in the camera's detection range.

According to an example embodiment of the present invention, the detection unit is preferably designed as an acceleration sensor and/or a rotation rate sensor for detecting movement of the connecting line. The detection unit can, for example, be designed to recognize an animal when a detected movement of the connecting line corresponds to a predefined movement pattern. In particular, this makes it possible to differentiate between a movement of the connecting line that is carried out to connect the vehicle and the energy supply apparatus or load and a movement of the connecting line that is initiated by an animal. This reduces the likelihood of incorrect detection of animals. By designing the detection unit as a rotation rate sensor or acceleration sensor, a simple and cost-effective provision of the detection unit is achieved. Another advantage is that damage to the supply cable caused by other, e.g., external, events can be detected and a user can be informed of this, e.g., damage caused by the supply cable or one of its components being rolled over. It is understood that the sensor detects any movement of the supply cable and that the detected signal can be used to detect any damage.

According to an example embodiment of the present invention, the output unit is advantageously designed as a flashing light module. The flashing light module is designed, for example, to output flashing light as a scaring signal. The scaring signal described above is therefore a flashing light that is particularly suitable for scaring martens and/or rats and/or mice. For example, flashes of light with a frequency between one Hertz and one kilohertz can be output. Light energy, for example, is between 0.1 joules and 10 joules. The light energy is particularly advantageously dependent on the ambient brightness, so that lower light energies are used in darker environments, such as at night or dusk, than in brighter environments, such as during the day.

According to an example embodiment of the present invention, the output unit is advantageously designed as an acoustic module for outputting sound. This sound is particularly advantageous as an ultrasound and is preferably intended as a scaring signal. The use of ultrasound as a scaring signal means that humans do not perceive these scaring signals, or perceive them only to a very limited extent. This means, for example, that an uninvolved person in the surroundings of the supply cable is not startled when an animal is scared off. A sound pressure of the output sound is advantageously increasing in time, so that the scaring signal becomes louder over time if the scaring with the quieter signal is not successful.

In an advantageous embodiment of the present invention, the detection unit is designed to detect animals only during a predefined time window. For example, detection can only take place at night and/or when it is dark and/or at dusk. Alternatively or additionally, the output unit is designed to output scaring signals only during a (further) predefined time window. This time window is also preferably at night and/or in when it is dark and/or at dusk. Martens in particular are mainly active at dusk or at night, which means that these animals pose a greater danger at night and/or at dusk than at other times of day. Therefore, it is possible to dispense with the detection of animals or the output of scaring signals outside of these times of day in order to save energy and/or avoid false alarms.

In a further alternative or additional embodiment of the present invention, the detection unit and/or the output unit can be designed to perform the detection of animals or the output of scaring signals only at low brightness. A brightness sensor can be provided for this purpose, for example. If the brightness falls below a certain value, the detection unit and/or the output unit can be activated. In such an embodiment, the detection or output of the at least one scaring signal can take place independently of a specific time of day depending on the ambient brightness. This has the advantage that in a dark place, e.g., in an underground garage, light-shy animals such as rodents, e.g., rats or mice, can also be active during the day. By activating the detection unit and/or the output unit when the ambient brightness is low, such nocturnal and/or crepuscular animals can be detected and/or scared off.

According to an example embodiment of the present invention, the supply cable preferably has a communication unit. The communication unit is designed to emit a warning signal when the detection unit has detected an animal. The warning signal is preferably sent to a user terminal. If the detection unit detects an animal in its detection range, there is still a residual risk of an animal biting the connecting line or other components of the supply cable despite the scaring signals emitted. The user of the supply cable is warned of this danger by the output of the warning signal, in particular to the user terminal. The user can thus, for example, go to the location of the supply cable and drive the animal away. The user can also be prompted by the warning signal to inspect the supply cable in order to find any damage. The detection of an animal in the detection range is carried out by the detection unit. The detection unit can have a plurality of even spatially separated, components, wherein one of these components detects the detection range, while another of these components specifically recognizes an animal from the data or signals of the first component. The communication unit therefore keeps the user of the supply cable informed about the status of the supply cable at all times.

According to an example embodiment of the present invention, the at least one communication unit can be arranged on or in the primary connector or on or in a housing of the primary connector and/or on or in the secondary connector or on or in a housing of the secondary connector and/or on or in the supply line. The communication unit can also be designed to communicate, in particular to transmit and receive, other signals, e.g., to communicate with the vehicle and/or the energy supply unit and/or the energy supply apparatus and/or the load. Communication with a cloud server or cloud storage may also be possible. The communication unit can, for example, be designed to receive and/or transmit WLAN signals, mobile radio signals (e.g., in the 2G, 3G, 4G, 5G, 6G, etc. standard), Bluetooth signals, NFC signals, without being limited to these signal types.

Alternatively or additionally, the supply cable can be designed to suppress the output of scaring signals when the communication unit detects signals from mobile devices in the surroundings of the supply cable. In this situation, the at least one scaring signal can be suppressed, for example, if it is detected that the mobile device is moving.

This has the advantage that a person approaching the supply cable, who may be incorrectly recognized as an animal by the detection unit, is not startled or disturbed by the transmission of scaring signals. If a person is in the surroundings of the supply cable, e.g., within an area of approximately 12 m around the supply cable or the communication unit or within an area of less than 12 m or less than 8 m or less than 5 m, it can be assumed that (at least healthy) animals such as rats, mice or martens will flee and therefore there is no risk of the cable being bitten. The fact that many people carry mobile devices equipped with an active and/or passive transmitter can be used to detect whether a person is in the surroundings of the supply cable. For example, mobile devices can be mobile wireless devices such as smartphones, tablets, laptops, smartwatches, etc., but also pacemakers, RFID tags or similar objects. The communication unit can, for example, receive Bluetooth signals, NFC signals, WLAN signals, MAC signatures, etc. from such terminals. To detect, for example, RFID tags, the communication unit can send activation signals, for example, and then receive the RFID identifier of the RFID tag. For example, the intensity of such signals and/or their progression over time, etc. can be used to determine whether they are static signals, e.g., from a vehicle parked nearby. In such a case, the suppression of the transmission of the scaring signals could be inhibited. However, if a person moves through the space carrying at least one mobile device, the signal strength changes depending on the distance between the person and the communication unit. From this it can be concluded that there is a high probability that a person (or, for example in the case of autonomously parked vehicles, a vehicle, which also triggers an escape reflex in animals) is in the surroundings of the supply cable. In this case, the transmission of scaring signals can be suppressed even if the detection unit recognizes an animal (e.g., this could be a dog or cat escorted by a human or the human is incorrectly identified as an animal). In particular, the output of the at least one scaring signal can be suppressed even when a typical movement pattern of the supply line is detected in the event that a signal of a mobile device, in particular a moving mobile device. This means that a person who shakes or rolls up the supply cable is not startled.

The interruption of the transmission of the scaring signal can, for example, last as long as a mobile device, in particular a movement of the mobile device, is detected. It can also be prevented for a predefined period of time, e.g., 30 seconds or 1 minute, etc., after the detection of the mobile device or the detection of the last movement of the mobile device has ended, even if the detection unit detects or recognizes an animal during this period. However, it is also possible to prevent the transmission of scaring signals for a predefined period of time, e.g., 30 seconds, 1 minute, etc., after the mobile device has been detected. If no new (different) signal is detected after this predefined duration has elapsed, the suppression of the transmission of the scaring signal can be terminated.

In a particularly preferred embodiment of the present invention, it can be provided that the output of scaring signals is suppressed when the communication unit receives a predefined signal. This can be, for example, a special identifier for one or more mobile devices. In this way, for example, an owner or user of the supply cable can be recognized, so that scaring signals are not emitted when this user is in the surroundings of the supply cable, in particular when it is moving in the surroundings of the supply cable. For example, when connecting the supply cable to a vehicle and/or an energy supply apparatus and/or a load, the signature or identifier of all devices located in the surroundings can be recorded and stored by the communication device. It is also possible to detect which of these signals is moving. This allows conclusions to be drawn about the user's device. Alternatively or additionally, it is also possible for a user to store one or more of their devices or the signatures thereof in the communication unit or in the supply cable. In this way, the supply cable or the communication unit can detect that this device, and therefore most likely the user, is in the surroundings, especially if the signal varies in strength over time, for example, which indicates movement.

The supply cable is preferably designed to interrupt a current flow through the supply cable when an animal is detected by the detection unit and/or to output a stop signal to a vehicle connected to the primary connector to interrupt a current flow through the supply cable and/or to output a stop signal to an energy supply apparatus connected to the secondary connector to interrupt a current flow through the supply cable. As described above, when the animal is detected by at least one component of the detection unit, there is still a residual risk of an animal biting the supply cable. In order to protect the animal from high electrical voltages on the one hand and protect the vehicle and/or the energy supply apparatus from short circuits on the other, the current flow through the supply cable is interrupted. This interruption can be caused either by the supply cable itself or by the components connected to the supply cable. In particular, a signal can be sent to the vehicle and/or the energy supply apparatus to interrupt said current flow. This means that the supply cable is in a safe operating condition. It is particularly preferable that when it is detected that the animal is no longer in the detection range of the detection unit, the flow of current through the supply cable is permitted again. This can be done either directly via the supply cable or by outputting a corresponding start signal to start the flow of current to a vehicle connected to the primary connector or to an energy supply apparatus connected to the secondary connector.

In a preferred embodiment of the present invention, the connecting line has a bite-inhibiting sheath. The bite-inhibiting sheath can actively prevent a bite on the one hand and passively protect at least the electrical conductors of the connecting line from animal biting on the other. This provides a further safety level in addition to the scaring signals to prevent damage to the supply cable and short circuits.

Particularly advantageously, the bite-inhibiting coating has a metal mesh or a metal net or a chemical repellent, such as pungent substances and/or substances smelling of animal predators or humans. The chemical repellent has a beneficial effect against rodents or predators. The use of metal grids or metal nets means in particular that an animal bite cannot be carried further than the metal grid or metal net. In addition, a metal grid or metal net can be uncomfortable for an animal, preventing further biting or a more extensive biting. Advantageously, such a metal grid or metal mesh is designed in such a way that it does not restrict the flexibility and/or pliability of the connecting line and does not increase the thickness of the connecting line or only increases it slightly, e.g., by a maximum of 3 mm, preferably by a maximum of 2 mm and most preferably by a maximum of 1 mm. The use of a chemical repellent prevents the animal from biting the connecting pipe. The chemical repellent is particularly effective against martens and/or rats and/or mice.

The bite-inhibiting sheath is particularly preferably part of an electrical insulation sheath of the connecting line. Alternatively, the bite-inhibiting sheath is designed as a further sheath in addition to the insulation sheath. This type of sheath is particularly advantageous because it is just as pliable and flexible as the supply line that is not sheathed by it. Furthermore, it advantageously does not increase the thickness of the connecting line or increases it only slightly, e.g., by a maximum of 3 mm, preferably by a maximum of 2 mm and particularly preferably by a maximum of 1 mm. In particular, the manageability of the supply cable is not impaired or not significantly impaired. A user of the supply cable can therefore fold it up easily and with little effort in order to store the supply cable in the trunk of a vehicle.

The present invention further relates to a primary connector. The primary connector is suitable for use with a supply cable that is designed to electrically connect a vehicle, in particular an energy storage device of a vehicle, to an energy supply apparatus that supplies electrical energy and/or to a load that requires electrical energy. The primary connector has a vehicle terminal designed for detachably electrically connecting to the vehicle, in particular the energy storage device. Furthermore, the primary connector has a detection unit and/or an output unit. The detection unit is designed to detect animals in the surroundings, in particular the area surrounding the primary connector. Detection is carried out in particular by means of optical and/or acoustic detection and/or by detection based on echo ranging and/or movement patterns of the supply cable. The surroundings are in particular the area surrounding the detection unit, preferably the surroundings of the primary connector and in particular the surroundings of the supply cable. For example, an area around the primary connector or the supply cable of up to 10 m or up to 5 m or up to 3 m can be covered. The primary connector thus enables the detection of animals via the detection unit, wherein in particular animals that are dangerous for the primary connector or for the supply cable, for example because there is a risk of animal biting, can be detected. The output unit provided alternatively or additionally to the detection unit serves to output scaring signals or at least one scaring signal or at least one type of scaring signal for scaring an animal. This animal has been detected by the detection unit of the primary connector and/or by a detection unit of the supply cable. The primary connector in conjunction with the output unit therefore makes it possible to scare off animals. It is irrelevant whether said animal was detected by the primary connector or by another component of the supply cable, i.e., it is irrelevant whether the detection unit is realized on the primary connector itself, as described above, or alternatively on another component of the supply cable. By scaring the animal using the output unit, not only the safety of the primary connector can be increased, but also the safety of the entire supply cable. The primary connector is advantageously coupled to a connecting line of the supply cable. If an animal moves this connecting line, this also affects the primary connector. The effects of the movement of the connecting line on the primary connector can be detected in order to draw conclusions about the presence of an animal.

The present invention further relates to a secondary connector. A secondary connector is suitable for use with a supply cable that is designed to electrically connect a vehicle, in particular an energy storage device of a vehicle, to an energy supply apparatus that supplies electrical energy and/or to a load that requires electrical energy. The secondary connector has a secondary terminal that is used for a detachable electrical connection to the energy supply apparatus or to the electrical load. Furthermore, the secondary connector has a detection unit and/or an output unit. Furthermore, the secondary connector has a detection unit and/or an output unit. The detection unit is designed to detect animals in the surroundings, in particular the area surrounding the secondary connector. Detection is carried out in particular by means of optical and/or acoustic detection and/or by detection based on echo ranging and/or movement patterns of the supply cable. The surrounding area is in particular the area surrounding the detection unit, preferably the area surrounding the secondary connector and in particular the area surrounding the supply cable. For example, an area surrounding the secondary connector or the supply cable of up to 10 m or up to 5 m or up to 3 m can be covered. The secondary connector thus enables the detection of animals via the detection unit, wherein in particular animals that are dangerous for the secondary connector or for the supply cable can be detected, for example because an animal bite is feared. The output unit provided alternatively or additionally to the detection unit serves to output scaring signals or at least one scaring signal or at least one type of scaring signal for scaring an animal. This animal has been detected by the detection unit of the secondary connector and/or by a detection unit of the supply cable. The secondary connector therefore enables animals to be scared by the output unit. It is irrelevant whether said animal was detected by the secondary connector or by another component of the supply cable, i.e., it is irrelevant whether the detection unit is realized on the secondary connector itself, as described above, or alternatively on another component of the supply cable. By scaring the animal using the output unit, not only the safety of the secondary connector can be increased, but also the safety of the entire supply cable. The secondary connector is advantageously coupled to a connecting line of the supply cable. If an animal moves this connecting line, this also affects the secondary connector. The effects of the movement of the connecting line on the secondary connector can be detected in order to draw conclusions about the presence of an animal.

### BRIEF DESCRIPTION OF THE DRAWINGS

Exemplary embodiments of the present invention are described in detail below with reference to the figures.

FIG. 1 is a schematic illustration of a supply cable, according to an example embodiment of the present invention.

FIG. 2 is another schematic illustration of the supply cable, according to an example embodiment of the present invention.

FIG. 3 is a schematic illustration of the structure of a detection unit of the supply cable, according to an example embodiment of the present invention.

FIG. 4 is a schematic illustration of the structure of an output unit of the supply cable, according to an example embodiment of the present invention.

FIG. 5A is a schematic illustration of a cross section of a first alternative of a connecting line of the supply cable, according to an example embodiment of the present invention.

FIG. 5B is a schematic illustration of a cross section of a second alternative of the connecting line of the supply cable, according to an example embodiment of the present invention.

### DETAILED DESCRIPTION OF EXAMPLE EMBODIMENTS

All figures are solely schematic representations of the device according to the present invention or of its components according to exemplary embodiments of the present invention. In particular, distances and size relationships are not reproduced true to scale in the figures. In the various figures, corresponding elements are provided with the same reference numbers.

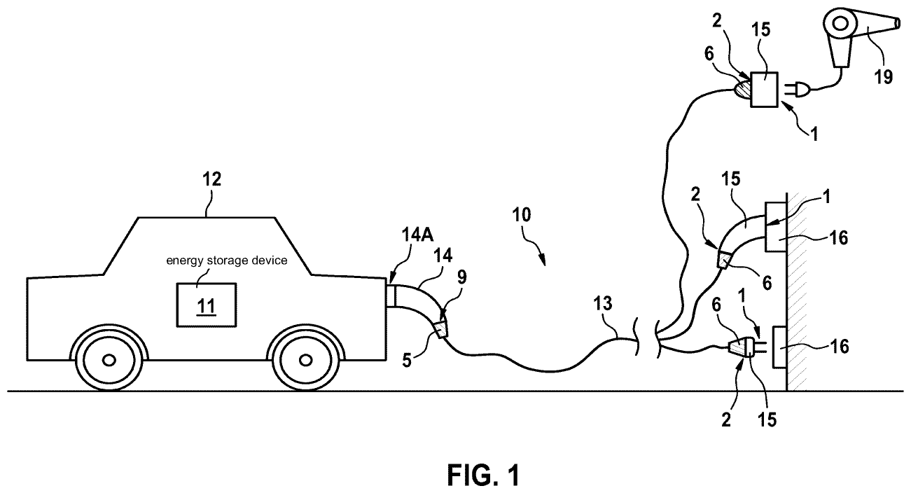

FIG. 1 schematically shows a vehicle 12 which is, for example, a hybrid or electric vehicle and which has an energy storage device 11. The energy storage device 11 is to be charged here, for example, via an energy supply apparatus 16. The energy supply apparatus 16 in the case shown in FIG. 1 can be, for example, a wallbox that enables charging with three-phase alternating voltage, or a continuous voltage source, for example a household socket such as a Schuko socket, which enables single-phase charging, for example. A supply cable 10 according to an exemplary embodiment of the present invention is provided for connecting the energy supply apparatus 16 and the energy storage device 11 or vehicle 12.

The supply cable 10 has a primary connector 14 and a secondary connector 15, wherein different variants of the secondary connector 15 are shown in FIG. 1. There is a supply line or connecting line 13 between the primary connector 14 and the secondary connector 15. The primary connector 14 is used for electrical connection to the vehicle 12 and especially to the energy storage device 11. Depending on its design, the secondary connector 15 is used for connection to the various types of energy supply apparatus 16 or a load 19. In the event that the secondary connector 15 is set up for connection to a load 19 (shown here by way of example in the form of a hair dryer), the secondary connector 15 can be a Schuko socket, for example. In this case, electrical energy is drawn from the vehicle 12 or its energy storage device 11. It is understood that the electrical load can also be a power grid, so that electrical energy from the vehicle 12 can be fed back into the power grid. In this case, for example, a Schuko plug or a type 2 charging plug for plugging into a wallbox can serve as a secondary connector 15. It is further understood that the electrical load can also be another vehicle, which is supplied with electricity or electrical energy from the vehicle 12. In this case, the secondary connector 15 can be designed in the same way as the primary connector 14, for example.

The primary connector 14 has a vehicle terminal 14A which is provided for indirect or direct detachable wireless or wired electrical connection to the vehicle 12 or the energy storage device 11.

In the embodiment shown, the primary connector 14 also has an additional terminal 9 via which a wireless and/or wired electrical connection can be established directly or indirectly in a detachable manner with an additional coupling 5 of the connecting line 13. In an alternative embodiment, the additional terminal 9 and the additional coupling 5 can be dispensed with, so that the connecting line 13 is attached directly to the primary connector 14 and cannot be separated from it in a non-destructive manner.

In the exemplary embodiment shown, the supply cable 10 can be coupled with various types of secondary connectors 15. Each secondary connector 15 has an infrastructure terminal 1 and a cable connection 2, wherein the infrastructure connection 1 is designed for electrical connection to the energy supply apparatus 16 or the load 19. The cable connection 2 is used to connect to the connection line 13. The connecting line 13 has a coupling 6, for example, wherein the coupling 6 and the cable connection 2 can be electrically connected in a detachable manner. This means that the secondary connectors 15 can be replaced easily and with little effort by simply disconnecting the connection between coupling 6 and cable connection 2. In principle, supply cables 10 are of course also possible in which the secondary connector 14 is connected to the connecting line 13 in a non-detachable (i.e., not non-destructively detachable) manner.

FIG. 1 shows at the top right that the infrastructure terminal 1 can also be designed by way of example for connection to a load 19, e.g., by designing the infrastructure terminal 1 or the secondary connector 15 as a Schuko socket or as a three-phase socket. FIG. 1 shows at the center right that the infrastructure terminal 1 of the secondary connector 15 can, for example, be a type 2 connection for connection to a charging station or wallbox in an alternative embodiment (in this case, for example, a current flow from the infrastructure terminal 1 to the vehicle 12 or from the vehicle 12 to the infrastructure terminal 1 is possible). In FIG. 1 shows at the bottom right by way of example that the infrastructure terminal 1 of the secondary connector 15 can, in an alternative embodiment, be a Schuko plug for connection to a household socket (here too, for example, a current flow from the infrastructure terminal 1 to the vehicle 12 or from the vehicle 12 to the infrastructure terminal 1 is possible). A secondary connector 15 for connecting to another vehicle is also possible in principle, but is not shown here.

In this exemplary embodiment, the connecting line 13 only has electrical conductors between the clutch 6 and the additional clutch 5 which establish an electrical connection between the clutch 6 and the additional clutch 5. These electrical conductors are copper conductors or aluminum conductors, for example, or they are made of another material with high electrical conductivity and have electrical insulation. All electrical conductors are assembled in one strand, for example, and preferably have a common sheath that serves as electrical insulation on the one hand and mechanical protection on the other. Preferably, no active or passive electrical component is provided in the connecting line 13 in FIG. 1. All logic components or logic modules (e.g., microprocessors, ASICs, etc.) and in particular active or passive electrical components are either part of the primary connector 14 and/or part of the secondary connector 15. As a result, the connecting line 13 can be manufactured cost-effectively. An ICCB (an in-cable control box) can therefore be expressly dispensed with in this exemplary embodiment. As a result, the supply cable 10 can be provided in a cost-effective, compact, simple, space-saving and lightweight manner despite its adaptability as shown here (various secondary connectors 15 can be connected as required). Dispensing with an ICCB reduces not only weight, costs and manageability, but also time-consuming quality checks and load tests, because it is not necessary to secure the sensitive electronics of the ICCB against being driven over by other vehicles, e.g., trucks. This also has the advantage of reducing the risk of people tripping. It is understood that in other exemplary embodiments an ICCB can be provided which is then arranged, for example, within the connecting line 13.

FIG. 2 schematically shows a further illustration of the supply cable 10. Various positions for a detection unit 20 and an output unit 21 are shown. It is sufficient if a detection unit 20 and/or an output unit 21 is present in at least one of the positions shown. The supply cable 10 thus has at least one detection unit 20, which is used to detect animals in the surroundings of the supply cable 10. In addition, the supply cable 10 has at least one output unit 21, which is used to output scaring signals. In principle, it is possible for the detection unit 20 to be physically separate from the output unit 21.

If an animal, in particular an animal that is potentially harmful to the supply cable 10, in particular a mammal, in particular a rodent or predator such as a rat or a mouse or a marten (or an animal known in parts of the world other than Europe as a harmful animal for animal biting on cables/lines), is in the surroundings of the supply cable 10, there is a risk of animal biting. This danger exists in particular on the connecting line 13. If an animal bites the connecting line 13 or another component of the supply cable 10, there is a risk of short circuits and damage to the supply cable 10 and/or vehicle 12 and/or energy supply apparatus 16 and/or (electrical) load 19. The detection unit 20 is used to detect animals, in particular by means of optical and/or acoustic detection and/or by detection based on echo ranging and/or movement patterns of the supply cable 10, in particular the connecting line 13. If the detection unit 20 detects an animal in its detection range, the supply cable 10 is designed to output scaring signals via the output unit 21 to scare off the animal. The scaring signals are in particular predefined signals that are suitable for scaring off animals, in particular the aforementioned animals. In an advantageous embodiment, a classification of the detected animals is provided in order to emit scaring signals specifically tailored to the recognized classification of the animal.

The animal is scared off by the scaring signals, which minimizes the risk of it biting a cable and thus damaging the supply cable. It also reduces the risk of the animal coming into contact with live components of the supply cable 10 if it bites the cable. However, despite the scaring signals, there is still a residual risk that the animal will not be scared off and will bite the supply cable 10. Therefore, by way of example, a communication unit 22 is provided which is configured to output a warning signal to a user terminal 22A when the detection unit 20 has detected an animal. The user terminal 22A is particularly advantageously a cell phone, a smartwatch, a tablet, a PC or the like of a user of the supply cable 10. If the user receives a warning signal from the communication unit 22, the user can try to drive the animal away himself and/or check the supply cable 10 for damage, in particular for animal bites. This ensures safe operation of the supply cable 10. It may further be provided that the communication unit 22 or an evaluation unit detects mobile devices, such as a smartphone, a tablet, a laptop, a smartwatch, a pacemaker, an RFID tag, etc. For this purpose, their signals, e.g., Bluetooth signals, WLAN signals, mobile radio signals (2G, 3G, 4G, 5G, 6G, etc.), MAC addresses, NFC signals, etc., can be detected. If such a signal is detected that indicates the presence of a human or the user of the supply cable 10 in the surroundings the supply cable 10 (e.g., less than 12 m or less than 10 m or less than 8 m or less than 5 m), the transmission of the at least one scaring signal can be suppressed. This interruption of the transmission of the at least one scaring signal can preferably take place when it is detected that the mobile device is moving. This can prevent, for example, a cell phone forgotten in the vehicle from suppressing the transmission of the scaring signals even though there is no human in the surroundings to keep an animal away or drive it away from the supply cable 10. Preventing the transmission of at least one scaring signal significantly increases the user's convenience, because he is not startled by scaring signals if the detection unit incorrectly identifies him as an animal. This also reduces the risk of, for example, a dog or cat owner being startled by the transmission of scaring signals when, for example, they are walking their dog or cat near a supply cable 10 and the detection unit identifies the dog or cat as an animal that is to be scared. If the at least one scaring signal is e.g., sound with a frequency that can be heard by animals in particular (e.g., more than 20 kHz), a pet owner could be confronted with sudden, unexpected reactions from his animal. Such a risk can be reduced by suppressing the transmission of scaring signals when detecting mobile devices, especially their movement.

Preferably, it is also provided that a current flow through the supply cable 10 is interrupted when an animal is detected by the detection unit 20. It is possible that such an interruption is only triggered if an animal is detected or recognized for a predefined period of time, e.g., longer than 10 seconds or longer than 30 seconds. Alternatively or additionally, it may be provided that the interruption occurs when one or more predefined scaring attempts have been made by means of the output unit 21 and the detection unit 20 continues to detect or recognize an animal. In this case, the supply cable 10 is designed either to interrupt the current flow itself or to output a corresponding stop signal to interrupt the current flow to the vehicle 10, which is connected to the vehicle terminal 14A of the primary connector 14, or to the energy supply apparatus 60, which is connected via the secondary terminal 1 of the secondary connector 15. A combination of these is also possible. This puts the supply cable 10 into a safe operating state when an animal is detected. It is particularly advantageous for the current flow to be resumed as soon as the detection unit 20 has recognized that the animal is no longer in the detection range. Preferably, it is additionally provided to wait for a predefined period of time to ensure that the animal has actually moved away from the supply cable 10 in order to avoid repeated starting and stopping of the current flow when the animal repeatedly enters and exits the detection area. For this purpose, the supply cable 10 is preferably designed to allow the flow of current again itself or to output a corresponding start signal to vehicle 12 and/or energy supply apparatus 16.

FIG. 2 shows by way of example that the detection unit 20 and the output unit 21 can be located on the primary connector 14 and/or the connecting line 13 and/or on the secondary connector 15. Furthermore, it is shown by way of example that the communication unit 22 is located on the primary connector 14 or is arranged or fastened on and/or in the primary connector 14. It can also be provided that the communication unit 22 can be located, for example, on the secondary connector 15 and/or the connecting line 13. Likewise, the detection unit 20 can have a plurality of components that separately perform the tasks of purely detecting the detection range and recognizing an animal from the detection signals or detection data of the other component, e.g., by means of evaluation electronics or the like. These components can also be spatially separated and distributed, for example, over primary connector 14 and/or secondary connector 15 and/or connecting line 13.

FIG. 3 schematically shows a structure of the detection unit 20. This detection unit 20 can be realized by different components or have different devices. Thus, it is advantageously provided that the detection unit is designed as an ultrasonic sensor 20A and/or as a camera 20B and/or as an acceleration sensor 20C and/or as a rotation rate sensor. The ultrasonic sensor 20A is used for active acoustic detection of the animal by emitted ultrasonic signals being reflected by the animal. The reflected sound signals can be used to determine whether an animal is present and, if so, the size and/or surface characteristics of the animal and the distance at which it is located. The camera 20B is used to optically detect the surroundings, wherein this data can be used to recognize whether an animal is in the detection range of the camera 20B. The acceleration sensor 20C or rotation rate sensor is used to detect a movement of the connecting line 13, wherein in particular characteristic movements caused by an animal can be detected, e.g., shaking movements that follow a bite of the animal into the connecting line 13 and a subsequent “fight” with the connecting line 13. If such a characteristic movement is detected, the presence of an animal can be inferred. Alternatively or additionally, passive acoustic detection can also be carried out so that the presence of an animal is detected by means of noises caused or emitted by the animal. The supply cable 10 can only have a brightness sensor, for example, which is not shown in detail here. This can be used to activate the detection unit 20 and/or the output unit 21 depending on the ambient brightness, e.g., only when the brightness falls below a predefined level, e.g., at dusk or when it is dark. Alternatively or additionally, a time measuring unit, e.g., a clock or a receiver of time signals from the vehicle 12 or the energy supply apparatus 16, may be provided, which is also not shown here. This timing unit can be used to activate the detection unit 20 and/or the output unit 21 depending on the time of day, for example.

FIG. 4 schematically shows the structure of the output unit 21. The output unit 21 is preferably designed as a flashing light module 21A and/or as an acoustic module 21B. The flashing light module 21A is used to output flashing light as a scaring signal. The acoustic module 21B is used to output sound as a scaring signal. The output sound is in particular an ultrasound. The use of ultrasound means that the scaring signal cannot be perceived, or can be perceived only to a very limited extent, by humans, which is why there is no impact or at least very little impact on humans despite the animals being scared.

If the flashing light module 21A is used to scare off animals, the output light energy is advantageously adjusted based on the brightness of the surroundings. The darker the surroundings, the less the output light energy can be, for example. For example, a light energy of between 0.1 joules and 10 joules is output per flash. In particular, the flashes are output at a frequency between 1 Hz and 1 kHz. The color of the light output during the flash is irrelevant and in particular white.

The supply cable 10 is preferably designed to operate the detection unit 20 and/or the output unit 21 only within previously defined time periods. In particular, it is intended to detect animals only during a predefined time window, especially only at night and/or when it is dark and/or at dusk. Alternatively or additionally, it is intended to output scaring signals only during a predefined time window, in particular only at night and/or when it is dark and/or at dusk. Martens in particular are mainly active at night and at dusk, so there is an increased risk of marten biting at these times and a reduced risk outside these times. In order to save energy and/or to reduce the risk of false alarms and thus the unnecessary transmission of scaring signals, the detection of animals and/or the transmission of scaring signals is advantageously only carried out during these time windows, i.e., at night and/or when it is dark and/or at dusk. As described above, the activation of detection unit 20 and/or output unit 21 can additionally or alternatively also take place depending on the ambient brightness, for example, or animals can be detected or scaring signals can be output depending on the ambient brightness. For this purpose, for example, it is possible to provide just one brightness sensor on the supply cable 10.

In addition, it is preferable for further protection against animal biting to be provided on the connecting line 13 itself alongside the transmission of scaring signals. Compared to the primary connector 14 and the secondary connector 15, the connecting line 13 is the most susceptible to animal biting. Therefore, said further protection is provided, which is shown by way of example in FIG. 5A and FIG. 5B.

Both FIG. 5A and FIG. 5B show a cross section through the connecting line 13, wherein the connecting line 13 has a plurality of electrical conductors 25 which are surrounded by an insulation sheath 24. In addition to the insulation sheath 24, a bite-inhibiting sheath 23 is provided which comprises a metal mesh or a metal net or a chemical repellent, e.g., very pungent chemical substances or chemical substances smelling of a predator for the biting animals. The chemical repellent is particularly effective against rodents or predators, preferably mice and/or rats and/or martens. In one alternative, this bite-inhibiting sheath 23 is part of the insulation sheath 24, as shown in FIG. 5A. In another alternative, the bite-inhibiting sheath 23 is formed as a further sheath in addition to the insulation sheath 24, which is shown in FIG. 5B.

The use of metal grids or metal nets as a bite-inhibiting sheath 23 prevents animal biting at least as far as the electrical conductors 25. In addition, the bite-inhibiting coating 23, which is unpleasant for the animal, prevents the animal from continuing to bite into the connecting line 13. Although this causes damage to the insulation sheath 24, it prevents complete removal of the insulation sheath 24 and exposure of the electrical conductors 25. In the alternative shown in FIG. 5b, the insulation sheath 24 is also completely protected from animal biting.

If a chemical repellent is used as a bite-inhibiting coating 23, biting into the connecting line 13 is unpleasant for the animal, and for this reason the animal refrains from biting the connecting line 13 altogether. This protects the connecting line 13 from animal biting.

Together with the scaring signals, the bite-inhibiting sheath 23 thus increases the safety of the supply cable 10 against animal biting.

It may also be provided that a metal grid and/or metal mesh as described above is also provided on the primary connector 14 and/or secondary connector 15. Furthermore, it is possible that a housing of the primary connector 14 and/or the secondary connector has a coating with a chemical repellent and/or that such a chemical repellent is added to the material of such a housing. In this way, nibbling or biting on primary connectors 14 and/or secondary connectors 15 by an animal is also prevented, or the risk of this is reduced.

1-13. (canceled)

14. A supply cable for electrically connecting an energy storage device of a vehicle, to an energy supply apparatus that supplies electrical energy and/or to a load that requires electrical energy, the supply cable comprising:
a connecting line;
a primary connector which is electrically couplable or coupled to the connecting line and has a vehicle terminal for detachable electrical connection to the the energy storage device;
a secondary connector which is electrically couplable or coupled to the connecting line and has a secondary terminal which is provided for detachable electrical connection to the energy supply apparatus or to the electrical load;
a detection unit configured to detect animals in surroundings of the supply cable using: (i) optical and/or acoustic detection, and/or (ii) based on echo ranging and/or of movement patterns of the supply cable; and
an output unit configured to output scaring signals for scaring off a detected animal.

15. The supply cable according to claim 14, wherein the detection unit is an ultrasonic sensor and/or as a camera for detecting the animal.

16. The supply cable according to claim 14, wherein the detection unit is an acceleration sensor and/or as a rotation rate sensor for detecting a movement of the connecting line, and wherein the detection unit is configured to detect an animal when a detected movement of the connecting line corresponds to a predefined movement pattern.

17. The supply cable according to claim 14, wherein the output unit is a flashing light module, which is configured to output flashing light as a scaring signal.

18. The supply cable according to claim 14, wherein the output unit is an acoustic module configured to output ultrasound as a scaring signal.

19. The supply cable according to claim 14, wherein:
the detection unit is configured to detect animals only during a predefined time window, and/or
the output unit is configured to output scaring signals only during the predefined time window.

20. The supply cable according to claim 19, wherein the predefined time window is at night and/or when it is dark and/or at dusk.

21. The supply cable according to claim 14, further comprising:
a communication unit, wherein:
the communication unit is configured to transmit a warning signal to a user terminal when the detection unit has detected an animal, and/or
the supply cable is configured to suppress the output of scaring signals when the communication unit detects signals from a moving mobile device in the surroundings of the supply cable, the surroundings being a surrounding area of less than 12 m from the supply cable.

22. The supply cable according to claim 14, wherein the supply cable is configured to, upon detection of an animal by the detection unit:
interrupt a current flow through the supply cable, and/or
output a stop signal to a vehicle connected to the primary connector to interrupt a current flow through the supply cable, and/or
output a stop signal to an energy supply apparatus connected to the secondary connector to interrupt a current flow through the supply cable.

23. The supply cable according to claim 14, wherein the connecting line has a bite-inhibiting sheath.

24. The supply cable according to claim 23, wherein the bite-inhibiting sheath includes a metal mesh or a metal net or a chemical repellent which is effective against rodents or predators.

25. The supply cable according to claim 23, wherein the bite-inhibiting sheath is part of an electrical insulation sheath of the connecting line or is formed as a further sheath in addition to the insulation sheath.

26. A primary connector of a supply cable which is configured to electrically connect an energy storage device of a vehicle, to an energy supply apparatus that supplies electrical energy and/or to a load that requires electrical energy, wherein the primary connector comprises:
a vehicle terminal for detachable electrical connection to an energy storage device of the vehicle; and
(a) a detection unit configured to detect animals in surroundings using: (i) optical and/or acoustic detection, and/or (ii) detection based on echo ranging and/or movement patterns of the supply cable, and/or
(b) an output unit configured to output scaring signals for scaring off an animal which has been detected by the detection unit of the primary connector and/or by a detection unit of the supply cable.

27. A secondary connector of a supply cable which is configured to electrically connect an energy storage device of a vehicle, to an energy supply apparatus that supplies electrical energy and/or to a load that requires electrical energy, wherein the secondary connector comprises:
a secondary terminal for detachable electrical connection to the energy supply apparatus or to the electrical load; and
(a) a detection unit configured to detect animals in surroundings using: (i) optical and/or acoustic detection, and/or (ii) detection based on echo ranging and/or movement patterns of the supply cable, and/or
(b) an output unit configured to output scaring signals for scaring off an animal which has been detected by the detection unit of the secondary connector and/or by a detection unit of the supply cable.
